(19) United States
(12) Patent Application Publication
(10) Pub. No.: US 2019/0155347 A1
(43) Pub. Date: May 23, 2019

(54) PORTABLE ELECTRONIC DEVICE AND PROCESSOR CONTROL METHOD

(71) Applicant: FUJITSU LIMITED, Kawasaki-shi (JP)

(72) Inventors: Masatoshi Ishii, Kawasaki (JP); YOSHIYASU NAKASHIMA, Kawasaki (JP)

(73) Assignee: FUJITSU LIMITED, Kawasaki-shi (JP)

(21) Appl. No.: 16/158,357

(22) Filed: Oct. 12, 2018

(30) Foreign Application Priority Data
Nov. 21, 2017 (JP) 2017-223267

(51) Int. Cl. G06F 1/20; G01K 7/22; G06F 1/08; G06F 3/041; G05D 23/19

(52) U.S. Cl. CPC G06F 1/203; G01K 7/22; G06F 1/08; G05B 13/045; G06F 1/206; G05D 23/1917; G06F 3/0416

(57) ABSTRACT

A portable electronic device has a control unit including a processor whose clock frequency is variable, a temperature sensor, a housing that encases the control unit and temperature sensor, and a touch sensor that is able to detect touching to the surface of the housing. The control unit obtains a measured value of temperature from the temperature sensor, calculates an estimated value of surface temperature of the housing using the measured value and a first heat transfer model when the touch sensor has not detected touching, calculates the estimated value using the measured value and a second heat transfer model when the touch sensor has detected touching, decreases an upper limit for the clock frequency when the estimated value is higher than or equal to a threshold, and increases the upper limit for the clock frequency when the estimated value is lower than the threshold.

### CROSS-REFERENCE TO RELATED APPLICATION

This application is based upon and claims the benefit of priority of the prior Japanese Patent Application No. 2017-223267, filed on Nov. 21, 2017, the entire contents of which are incorporated herein by reference.

### FIELD

The embodiments discussed herein relate to a portable electronic device and a processor control method.

### BACKGROUND

With widespread use, portable electronic devices such as smartphones and tablet terminals have been becoming more multi-functional and more sophisticated. As the portable electronic devices advance in multi-functionality and sophistication, their processors generate more heat. However, it is not easy to improve the cooling performance of the portable electronic devices due to shape restriction. If a processor of a portable electronic device is under heavy load for a long time, the portable electronic device may fail to achieve sufficient cooling performance. Then, heat generated by the processor may propagate to the housing surface, and the surface temperature may rise accordingly.

If the surface temperature exceeds a threshold, limiting the operating frequency of the processor is considered as a method to reduce the surface temperature. However, due to shape restriction, it may be difficult to place a temperature sensor for directly measuring the surface temperature close to the housing surface. To deal with this, the surface temperature may be estimated from an internal temperature that is measured using a substrate inside the portable electronic device.

For example, a surface temperature estimation method for estimating surface temperature has been proposed. In this proposed surface temperature estimation method, a measured value of temperature is obtained from a temperature sensor located close to a processor on a substrate, and then surface temperature is calculated based on a previously defined heat transfer function between the processor and the temperature sensor and a previously defined heat transfer function between the processor and the housing surface. The former heat transfer function includes a thermal time constant that characterizes the transient response of heat transfer from the processor to the temperature sensor. The latter heat transfer function includes a thermal time constant that characterizes the transient response of heat transfer from the processor to the housing surface.

See, for example, Japanese Laid-open Patent Publication No. 2016-121985.

The housing surface of a portable electronic device is touched by a human body such as a palm or finger. A heat transfer rate of human body is higher than that of air, and a thermal resistance of human body is lower than that of air. Therefore, the surface temperature in the case where a human body touches the housing surface may be lower than the surface temperature in the case where only air touches the housing surface. However, the surface temperature estimation method described in the above-mentioned document is to estimate surface temperature on a premise that only air touches the housing surface.

Therefore, the surface temperature may be estimated to be higher than actual surface temperature, depending on the use conditions of the portable electronic device, and thus the operating frequency of the processor may be limited excessively. This causes a problem of degrading the processor's performance.

### SUMMARY

According to one aspect, there is provided a portable electronic device including: a control unit that includes a processor whose clock frequency is variable; a temperature sensor; a housing that encases the control unit and the temperature sensor; and a touch sensor that is able to detect touching to a surface of the housing, wherein the control unit is configured to: obtain a measured value of temperature from the temperature sensor; calculate an estimated value of surface temperature of the housing using the measured value and a first heat transfer model when the touch sensor has not detected the touching, and calculate the estimated value using the measured value and a second heat transfer model when the touch sensor has detected the touching; and decrease an upper limit for the clock frequency when the estimated value is higher than or equal to a first threshold, and increase the upper limit for the clock frequency when the estimated value is lower than the first threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for explaining a portable electronic device according to a first embodiment;

FIG. 2 is a block diagram illustrating an example of a hardware configuration of a portable terminal apparatus;

FIG. 3 illustrates an example of arrangement of components of the portable terminal apparatus;

FIG. 4 is a block diagram illustrating an example of a hardware configuration of a design apparatus;

FIG. 5 illustrates an example of a first thermal network model;

FIG. 6 illustrates an example of a second thermal network model;

FIG. 7 is a graph representing an example of relationship between heat source temperature and surface temperature;

FIG. 8 illustrates an example of a heat source area;

FIG. 9 is a block diagram illustrating an example of functions of the portable terminal apparatus and design apparatus;

FIG. 10 illustrates an example of a basic parameter table;

FIG. 11 illustrates an example of a coefficient table;

FIG. 12 illustrates an example of a delay data table;

FIG. 13 is a flowchart illustrating a process of determining transfer functions;

FIG. 14 is a flowchart illustrating a process of controlling a heat source according to a second embodiment;

FIG. 15 is a flowchart illustrating a process of controlling a heat source according to a third embodiment; and

FIG. 16 is a flowchart illustrating a process of controlling a heat source according to a fourth embodiment.

### DESCRIPTION OF EMBODIMENTS

Hereinafter, preferred embodiments will be described with reference to the accompanying drawings.

### First Embodiment

A first embodiment will now be described.

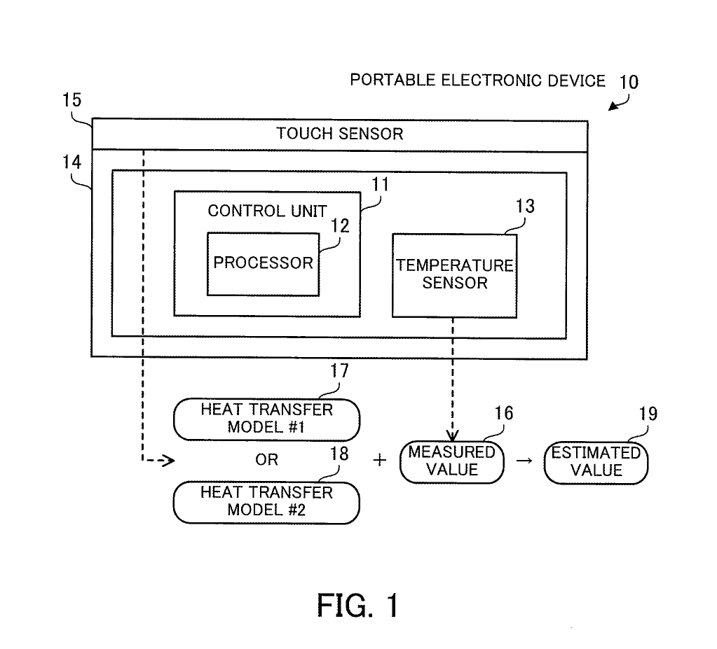

FIG. 1 is a view for explaining a portable electronic device according to the first embodiment.

The portable electronic device 10 of the first embodiment is a portable electronic device whose surface is touched by humans. Examples of the portable electronic device 10 include smartphones, portable telephones, tablet terminals, laptop computers, and others. The portable electronic device 10 estimates the current surface temperature, and when the surface temperature is high, controls a processor so as to reduce the surface temperature.

The portable electronic device 10 includes a control unit 11, a temperature sensor 13, a housing 14, and a touch sensor 15. The control unit 11 includes a processor 12. The processor 12 is able to change its clock frequency (may be called “operating frequency,” or simply “frequency”) according to load. The control unit 11 may set an upper limit (may be called “maximum clock frequency,” “maximum operating frequency,” or “maximum frequency”) for the clock frequency of the processor 12 to a lower clock frequency than a physical upper limit. The upper limit for the clock frequency is variable in multiple steps, like 1.0 GHz, 1.4 GHz, 1.8 GHz, and 2.0 GHz.

For example, the processor 12 is a Central Processing Unit (CPU), a Digital Signal Processor (DSP), a Graphics Processing Unit (CPU), or another. The control unit 11 may include another processor, for example, an Application-Specific Integrated Circuit (ASIC), Field Programmable Gate Array (FPGA), or another application-specific electronic circuit. The control unit 11 uses the processor 12, another processor, or another electronic circuit to control the clock frequency of the processor 12. In the case of using the processor 12 or another processor, the control unit 11 may run a processor control program describing an intended process (to be described later). The processor control program is stored in a volatile memory, such as a Random Access Memory (RAM), or a non-volatile storage, such as a flash memory.

The temperature sensor 13 is a sensor device that measures temperature at the location of the temperature sensor 13. The temperature sensor 13 is a thermistor, for example. The portable electronic device 10 may have a plurality of temperature sensors including the temperature sensor 13 at different locations. The temperature sensor 13 is preferably located close to the processor 12.

The housing 14 defines the outline of the portable electronic device 10. The housing 14 encases the control unit 11 and temperature sensor 13. The processor and temperature sensor 13 are mounted on the same substrate encased in the housing 14, for example.

The touch sensor 15 is a sensor device that is able to detect touching to the surface of the housing 14. The touch sensor 15 may be called “touch panel.” The touch sensor 15 is expected to determine whether a human body such as a palm or finger touches the surface of the housing 14, and for example, is placed on the surface of the housing 14. The touch sensor 15 is placed on the back of the portable electronic device 10 opposite to the front where the display of the portable electronic device 10 is provided. In this connection, a touch sensor on the front of the portable electronic device 10, which is able to detect touching to the display, is usable as the touch sensor 15. The touch sensor 15 may be placed on a side of the portable electronic device 10, which is neither the front nor the back thereof. As a position detection method, a matrix switch type, a resistance film type, a surface acoustic wave type, an infrared type, an electromagnetic induction type, an electrostatic capacitance type, or the like may be employed.

The control unit 11 obtains a measured value 16 of temperature from the temperature sensor 13. In addition, the control unit 11 determines whether the touch sensor 15 has detected touching. At this time, the control unit 11 may be designed to detect touching to a specific heat source area corresponding to the location of the processor 12 on the surface of the housing 14. The heat source area is an area to which most of heat from the processor 12 propagates on the surface, like an area above the processor 12. The touch sensor 15 may be provided only in the heat source area. Alternatively, the touch sensor 15 may be entirely arranged on a single surface (for example, entire back surface) including the heat source area, and the control unit 11 may be designed to determine whether the touched position detected by the touch sensor 15 is within the heat source area.

The control unit 11 calculates an estimated value 19 of surface temperature of the housing 14, using the measured value 16 and a heat transfer model 17 (first heat transfer model) in the case where the touch sensor 15 has not detected touching. In the case where the touch sensor 15 has detected touching, the control unit 11 calculates the estimated value 19 using the measured value and a heat transfer model 18 (second heat transfer model).

For example, the heat transfer models 17 and 18 are functions using parameter values that characterize heat transfer from the processor 12, which is a heat source, to the temperature sensor 13 and parameter values that characterize heat transfer from the processor 12 to the surface of the housing 14. For example, information indicating the heat transfer models 17 and 18 is stored in a storage device of the portable electronic device 10. The heat transfer models 17 and 18 are different from each other in that the heat transfer model 17 is built on a premise that a human body does not touch the housing 14, whereas the heat transfer model 18 is built on a premise that a human body touches the housing 14. In the case where the same measured value 16 is used, the estimated value 19 calculated using the heat transfer model 18 is expected to be lower than that calculated using the heat transfer model 17.

The heat transfer models 17 and 18 are built by an information processing apparatus other than the portable electronic device 10, for example. The built heat transfer models 17 and 18 may be implemented in the portable electronic device 10, at the time when the portable electronic device 10 is manufactured or by distributing the heat transfer models 17 and 18 to the portable electronic device 10 over a network. Each of the heat transfer models 17 and 18 may be built using a thermal resistance and thermal time constant that characterize heat transfer from the processor 12 to the surface of the housing 14. The thermal resistance relates to the amount of heat transferred from the processor 12 to the surface of the housing 14, and the thermal time constant relates to its transfer rate. In general, the thermal resistance of the heat transfer model 17 and the thermal resistance of the heat transfer model 18 are different from each other, and the thermal time constant of the heat transfer model 17 and the thermal time constant of the heat transfer model 18 are different from each other.

If the calculated estimated value 19 is higher than or equal to a threshold, the control unit 11 decreases the upper limit for the clock frequency of the processor 12. This means that the control unit 11 imposes a more severe limit on the clock frequency of the processor 12 in order to suppress the generation of heat by the processor 12. In this connection, if the upper limit for the clock frequency has already reached a physical lower limit, the control unit 11 maintains the current upper limit for the clock frequency. If the calculated estimated value 19 is lower than the threshold, the control unit 11 increases the upper limit for the clock frequency of the processor 12. This means that the control unit 11 relaxes the limit for the clock frequency of the processor 12 in order to permit an increase in the generation of heat by the processor 12. In this connection, if the upper limit has already reached a physical upper limit, the control unit 11 maintains the current upper limit for the clock frequency.

As described above, the portable electronic device 10 of the first embodiment obtains a measured value 16 of temperature from the temperature sensor 13 encased in the housing 14 and determines whether the touch sensor 15 has detected touching to the surface of the housing 14. If no touching has been detected, the portable electronic device 10 calculates an estimated value 19 using the measured value 16 and the heat transfer model 17. If touching has been detected, the portable electronic device calculates the estimated value 19 using the measured value 16 and the heat transfer model 18. Then, if the estimated value 19 is higher than or equal to a threshold, the portable electronic device 10 decreases the upper limit for the clock frequency of the processor 12. If the estimated value 19 is lower than the threshold, the portable electronic device 10 increases the upper limit for the clock frequency of the processor 12.

The above approach makes it possible to estimate surface temperature, in the case where a human body touches the surface of the housing 14 and in the case where a human body does not touch the surface of the housing 14 separately, thereby improving the calculation accuracy of the estimated value 19. This reduces risks of calculating the estimated value 19 to be higher than actual surface temperature and of excessively limiting the clock frequency of the processor 12. As a result, it is possible to improve the performance of the processor 12 in the temperature control.

### Second Embodiment

A second embodiment will now be described.

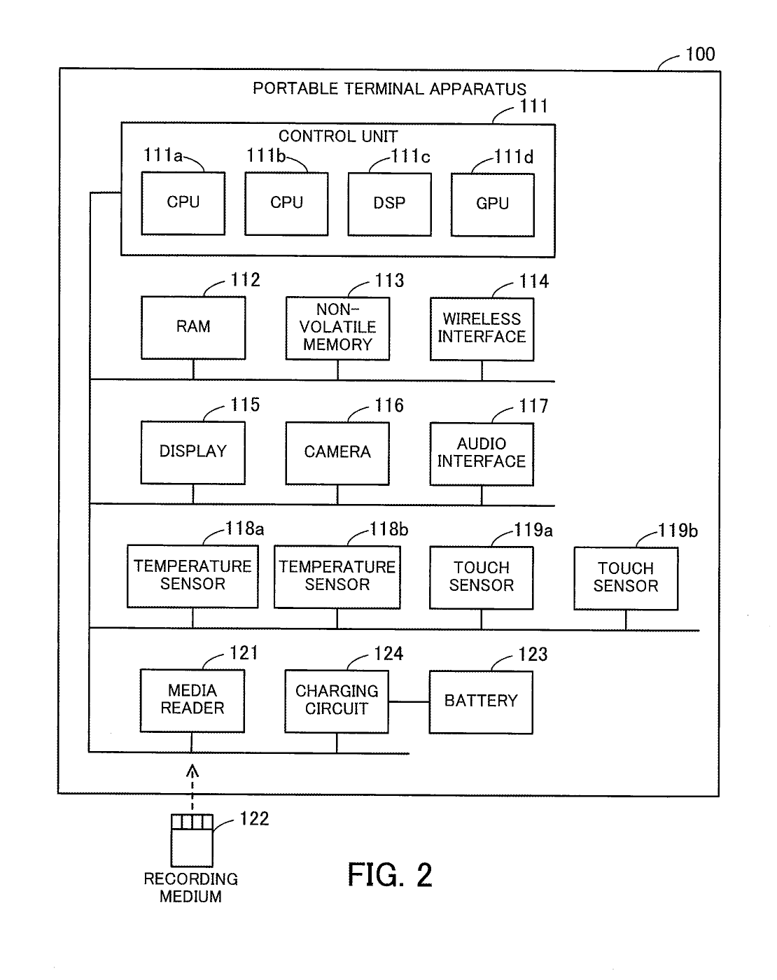

FIG. 2 is a block diagram illustrating an example of a hardware configuration of a portable terminal apparatus.

The portable terminal apparatus 100 of the second embodiment is a portable electronic device whose surface is touched by a user. Examples of the portable terminal apparatus 100 include smartphones, portable telephones, tablet terminals, laptop computers, and others. The portable terminal apparatus 100 corresponds to the portable electronic device 10 of the first embodiment.

The portable terminal apparatus 100 includes a control unit 111, a RAM 112, a non-volatile memory 113, a wireless interface 114, a display 115, a camera 116, and an audio interface 117. In addition, the portable terminal apparatus 100 includes temperature sensors 118a and 118b, touch sensors 119a and 119b, a media reader 121, a battery 123, and a charging circuit 124. In this connection, the control unit 111 corresponds to the control unit 11 of the first embodiment. The temperature sensor 118a corresponds to the temperature sensor 13 of the first embodiment. The touch sensor 119b corresponds to the touch sensor 15 of the first embodiment.

The control unit 111 controls the portable terminal apparatus 100. The control unit 111 includes CPUs 111a and 111b, a DSP 111c, and a GPU 111d. In this connection, the CPU 111a corresponds to the processor 12 of the first embodiment.

The CPUs 111a and 111b are processors each including a computational circuit that executes program instructions. The CPUs 111a and 111b load at least part of a program and data from the non-volatile memory 113 to the RAM 112, and run the program. The CPUs 111a and 111b each may include a plurality of CPU cores. Processes of the second embodiment may be executed in parallel using a plurality of CPUs or a plurality of CPU cores.

The DSP 111c processes digital signals. For example, the DSP 111c processes transmit signals to be transmitted from the wireless interface 114 and received signals received by the wireless interface 114. In addition, for example, the DSP 111c processes audio signals to be reproduced by the audio interface 117 or audio signals input to the audio interface 117. The GPU 111d processes video signals. For example, the GPU 111d generates images to be displayed on the display 115.

The RAM 112 is a volatile semiconductor memory for temporarily storing programs to be executed by the CPUs 111a and 111b and data to be used by the CPUs 111a and 111b in processing. In this connection, the portable terminal apparatus 100 may include various types of memories other than RAM or may include a plurality of memories.

The non-volatile memory 113 is a non-volatile storage device for storing software programs including Operating System (OS), middleware, and application software, and data. The programs include a program for estimating the surface temperature of the portable terminal apparatus 100. For example, a flash memory or Solid State Drive (SSD) may be used as the non-volatile memory 113. Alternatively, the portable terminal apparatus 100 may be provided with another type of non-volatile storage device, such as a Hard Disk Drive (HDD).

The wireless interface 114 is a communication interface for communication with another communication apparatus, such as a base station, via a wireless link. The portable terminal apparatus 100 may be provided with a wired interface for communication with another communication device, such as a switch or router, via a wired cable.

The display 115 displays images in accordance with instructions from the control unit 111. As the display 115, a Liquid Crystal Display (LCD), an Organic Electro-Luminescence (OEL) display, or another display may be used.

The camera 116 captures still images or moving images. The audio interface 117 includes a speaker for producing sounds and a microphone for collecting sounds.

The temperature sensors 118a and 118b measure temperature at their locations. For example, thermistors are used as the temperature sensors 118a and 118b. The temperature sensor 118a is located close to the CPU 111a, whereas the temperature sensor 118b is located sufficiently apart from a heat source, such as the CPU 111a. For example, the temperature sensor 118b is located close to the battery 123. The temperature sensors 118a and 118b notify the control unit 111 of measured temperature.

The touch sensors 119a and 119b are sensor devices that sense touching of a human body, such as user's palm or finger. The touch sensors 119a and 119b may be called touch panels. The touch sensor 119a lies over the display 115. The touch sensor 119b is located on the back opposite to the front where the display 115 is provided. The touch sensors 119a and 119b each detect a touched position of a finger or the like and notify the control unit 111 of the detected position. As a position detection method, a matrix switch type, a resistance film type, a surface acoustic wave type, an infrared type, an electromagnetic induction type, an electrostatic capacitance type, or the like may be employed. In this connection, the portable terminal apparatus 100 may additionally include a keypad or another input device. For example, the keypad includes one or more input keys. The keypad detects an input key pressed by a user and notifies the control unit 111 of the pressed input key.

The media reader 121 is a reading device for reading programs and data from a recording medium 122. As the recording medium 122, for example, a flash memory, a magnetic disk, such as a Flexible Disk (FD) or an HDD, an optical disc such as a Compact Disk (CD) or a Digital Versatile Disc (DVD), a Magneto-Optical disk (MO), or another may be used. The media reader 121 stores programs and data read from the recording medium 122, into the RAM 112 or non-volatile memory 113.

The battery 123 is a secondary battery that enables repeated charging and discharging. Electrical energy is stored in the battery 123 by the charging circuit 124. The battery 123 supplies the stored electrical energy to the constitutional components of the portable terminal apparatus 100. For example, the battery 123 supplies the electrical energy to the CPUs 111a and 111b and wireless interface 114. The charging circuit 124 obtains the electrical energy from an external power supply, which is provided outside the portable terminal apparatus 100, and charges the battery 123 with the electrical energy. The charging circuit 124 performs charging when the portable terminal apparatus 100 is connected to the external power supply.

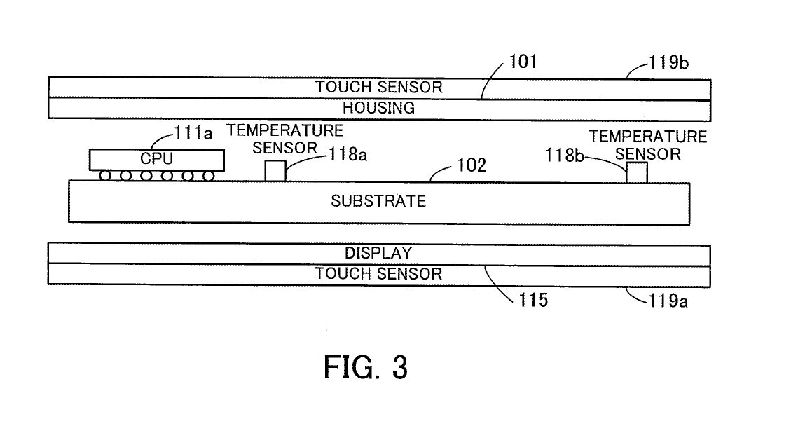

FIG. 3 illustrates an example of arrangement of components of the portable terminal apparatus.

The portable terminal apparatus 100 includes a housing 101 that defines the outline thereof and a substrate 102 that is encased in the housing 101. The housing 101 corresponds to the housing 14 of the first embodiment. The display 115 and touch sensor 119a are provided on the front of the portable terminal apparatus 100. The touch sensor 119b is provided on the back of the portable terminal apparatus 100.

The CPU 111a, which is a heat source, and temperature sensors 118a and 118b are mounted on the same plane of the substrate 102. The temperature sensor 118a is located in the vicinity of the CPU 111a, and the temperature sensor 118b is located sufficiently apart from the CPU 111a. The surface of the substrate 102 on which the CPU 111a and temperature sensors 118a and 118b are mounted faces the back side of the portable terminal apparatus 100. Therefore, in the surface of the housing 101, a heat source area where temperature greatly rises due to generation of heat by the CPU 111a is on the back surface where the touch sensor 119b is located.

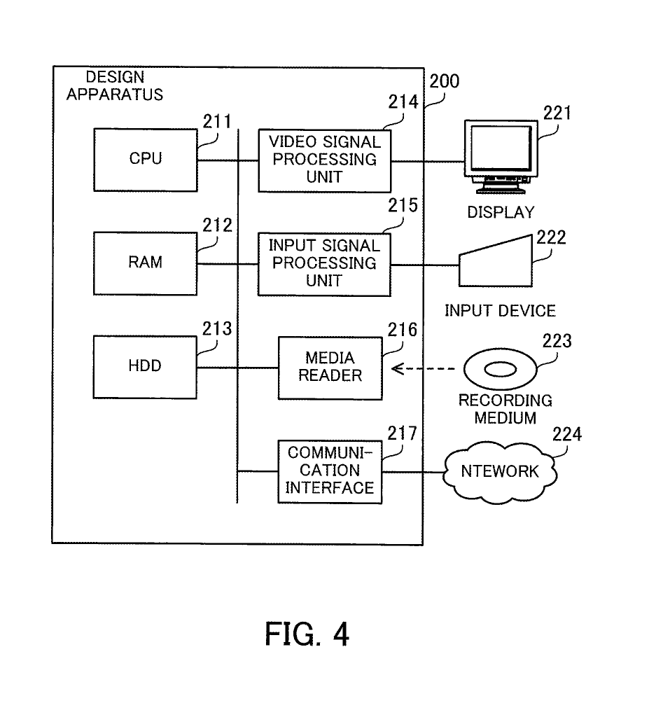

FIG. 4 is a block diagram illustrating an example of a hardware configuration of a design apparatus.

The design apparatus 200 of the second embodiment produces estimation equations for use in estimation of surface temperature of the portable terminal apparatus 100. The estimation equations produced by the design apparatus 200 are previously stored in the non-volatile memory 113 of the portable terminal apparatus 100, for example. In this connection, the estimation equations may be sent from the design apparatus 200 or another apparatus to the portable terminal apparatus 100 over a network. The design apparatus 200 may be a client apparatus, such as a client computer that is operated by a user, or a server apparatus, such as a server computer.

The design apparatus 200 includes a CPU 211, a RAM 212, an HDD 213, a video signal processing unit 214, an input signal processing unit 215, a media reader 216, and a communication interface 217.

The CPU 211 is a processor including a computational circuit that executes program instructions. The CPU 211 loads at least part of a program and data from the HDD 213 to the RAM 212, and runs the program. The RAM 212 is a volatile semiconductor memory for temporarily storing programs to be executed by the CPU 211 and data to be used by the CPU 211 in processing. The HDD 213 is a non-volatile storage device for storing software programs including OS, middleware, and application software, and data. In this connection, the design apparatus 200 may be provided with another type of storage device, such as a flash memory or an SSD.

The video signal processing unit 214 outputs images to a display 221 connected to the design apparatus 200 in accordance with instructions from the CPU 211. The input signal processing unit 215 obtains an input signal from an input device 222 connected to the design apparatus 200 and outputs the input signal to the CPU 211. As the input device 222, a pointing device, such as a mouse, a touch panel, or a touchpad, a keyboard, a remote controller, a button switch, or another may be used. In addition, plural types of input devices may be connected to the design apparatus 200.

The media reader 126 is a reading device for reading programs and data from a recording medium 223. As the recording medium 223, for example, a magnetic disk, such as a flexible disk or an HDD, an optical disc, such as a CD or a DVD, a magneto-optical disk, a semiconductor memory, or another may be used. The media reader 126 stores programs and data read from the recording medium 223 into the RAM 212 or HDD 213, for example.

The communication interface 217 is connected to a network 224 to perform communication with another apparatus over the network 224. The communication interface 217 may be a wired communication interface that is connected to a communication device such as a switch with a cable or a wireless communication interface that is connected to a base station with a wireless link.

The following describes models representing heat transfer from the CPU 111a to the housing surface.

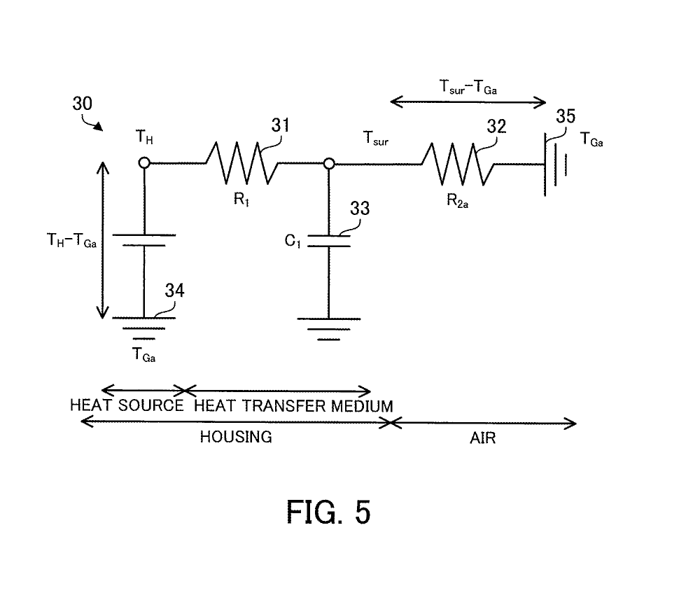

FIG. 5 illustrates an example of a first thermal network model.

The thermal network model 30 is built on a premise that a human body such as a palm or finger does not touch a housing surface, that is, only air touches the housing surface. The thermal network model 30 includes thermal resistance circuits 31 and 32, a thermal capacitance circuit 33, and the grounds (GND) 34 and 35. The housing 101 encases a heat source corresponding to the CPU 111a, and a heat transfer medium being in contact with the heat source and housing surface. The housing 101 is surrounded by air.

The heat source is connected to the ground 34. The thermal resistance circuit 31 is a circuit that represents the thermal resistance R₁ of the heat transfer medium. The thermal resistance circuit 31 is connected to the heat source. The thermal capacitance circuit 33 is a circuit that represents the thermal capacitance C₁ of the heat transfer medium. The thermal capacitance circuit 33 is connected to the thermal resistance circuit 31 and the ground. The thermal resistance circuit 32 is a circuit that represents the thermal resistance R₂ₐ of air. The thermal resistance circuit 32 is connected to the thermal resistance circuit 31, thermal capacitance circuit 33, and ground 35. A location sandwiched by the thermal resistance circuits 31 and 32 and the thermal capacitance circuit 33 corresponds to the housing surface.

In the thermal network model 30, heat source temperature T_{H}, reference location temperature T_{Ga}, and surface temperature Tₛᵤᵣ are defined. The heat source temperature T_{H} is the temperature of the CPU 111a. The reference location temperature T_{Ga} is an ambient temperature. The grounds 34 and 35 have the reference location temperature T_{Ga}. The surface temperature Tₛᵤᵣ is temperature at the contact between the housing 101 and the surrounding air. The location sandwiched by the thermal resistance circuits 31 and 32 and the thermal capacitance circuit 33 has the surface temperature Tₛᵤᵣ. A temperature difference between the heat source and the ground 34 is T_{H}−T_{Ga}. A temperature difference between both ends of the thermal resistance circuit 32 is Tₛᵤᵣ−T_{Ga}. Because of the thermal resistance R₁, the surface temperature Tₛᵤᵣ is lower than the heat source temperature T_{H}. In addition, because of the thermal capacitance C₁, a change of the surface temperature Tₛᵤᵣ lags behind a change of the heat source temperature T_{H}.

In the case of the thermal network model 30, Tₛᵤᵣ−T_{Ga} and T_{H}−T_{Ga} have relationship represented by expression (1). Therefore, the surface temperature Tₛᵤᵣ is calculated from the heat source temperature T_{H} and reference location temperature T_{Ga} as represented by expression (2). A heat transfer coefficient k_{Ga}=R₂ₐ/(R₁+R₂ₐ) represents the amount of change in the surface temperature Tₛᵤᵣ, and relates to a steady state that is obtained when sufficient time passes after a change in the heat source temperature T_{H}. The heat transfer coefficient may be called “k value.” A thermal time constant τ_{Ga}=C₁R₁R₂ₐ/(R₁+R₂ₐ) represents the change rate of the surface temperature Tₛᵤᵣ, and relates to a transient response that results from a change in the heat transfer temperature T_{H} and continues until the steady state is reached. The variable s is a variable in frequency domain after the Laplace transform. In this connection, in the following description, a variable in time domain may be represented as a variable t.

$$\begin{matrix}\begin{matrix}{T}_{sur} - {T}_{Ga} = \frac{{R}_{2 a}}{{R}_{1} + {R}_{2 a}} \frac{1}{1 + {sC}_{1} {R}_{1} {R}_{2 a} / ( {R}_{1} + {R}_{2 a} )} ( {T}_{H} - {T}_{Ga} ) \\ = \frac{{k}_{Ga}}{1 + s {τ}_{Ga}} ( {T}_{H} - {T}_{Ga} )\end{matrix} & ( 1 ) \\ {T}_{sur} = \frac{{k}_{Ga}}{1 + s {τ}_{Ga}} ( {T}_{H} - {T}_{Ga} ) + {T}_{Ga} & ( 2 )\end{matrix}$$

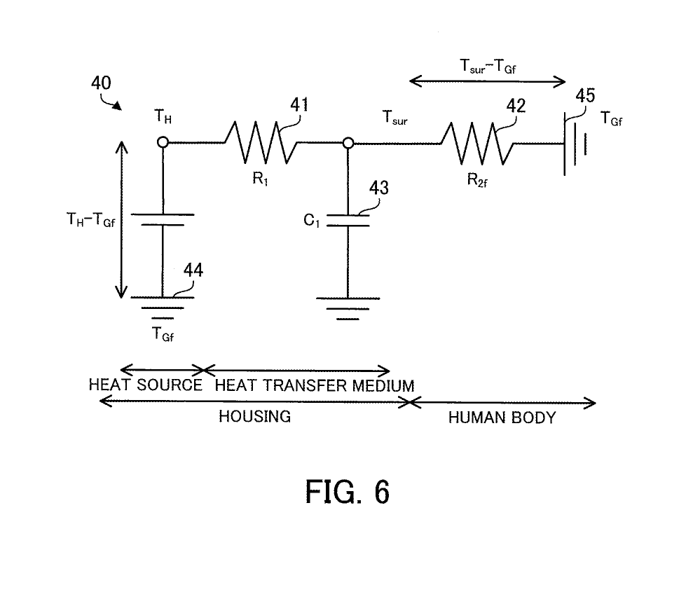

FIG. 6 illustrates an example of a second thermal network model.

The thermal network model 40 is built on a premise that a human body such as a palm or finger touches a housing surface. The thermal network model 40 includes thermal resistance circuits 41 and 42, a thermal capacitance circuit 43, and the grounds 44 and 45. The thermal resistance circuits 41 and 42 correspond to the thermal resistance circuits 31 and 32 of the thermal network model 30. The thermal capacitance circuit 43 corresponds to the thermal capacitance circuit 33 of the thermal network model 30. The grounds 44 and 45 correspond to the grounds 34 and 35 of the thermal network model 30.

The thermal resistance circuit 41 represents the thermal resistance R₁ of a heat transfer medium. The thermal capacitance circuit 43 represents the thermal capacitance C₁ of the heat transfer medium. The thermal resistance circuit 42 represents the thermal resistance R_{2f} of human body. Relationship R₂ₐ>R_{2f} is satisfied, as will be described later. In the thermal network model 40, heat source temperature T_{H}, reference location temperature T_{Gf}, and surface temperature Tₛᵤᵣ are defined. The reference location temperature T_{Gf} is body temperature. The grounds 44 and 45 have the reference location temperature T_{Gf}. The surface temperature Tₛᵤᵣ is temperature at the contact between the housing 101 and the human body. A location sandwiched by the thermal resistance circuits 41 and 42 and the thermal capacitance circuit 43 has the surface temperature Tₛᵤᵣ. A temperature difference between the heat source and the ground 44 is T_{H}−T_{Gf}. A temperature difference between both ends of the thermal resistance circuit 42 is Tₛᵤᵣ−T_{Gf}.

In the case of the thermal network model 40, Tₛᵤᵣ−T_{Gf} and T_{H}−T_{Gf} have relationship represented by expression (3). Therefore, the surface temperature Tₛᵤᵣ is calculated from the heat source temperature T_{H} and reference location temperature T_{Gf} as represented by expression (4). A heat transfer coefficient k_{Gf}=R_{2f}/(R₁+R_{2f}) represents a steady state that is obtained when sufficient time passes after a change in the heat source temperature T_{H}. The thermal time constant τ_{Gf}=C₁R₁R_{2f}/(R₁+R_{2f}) represents a transient response that results from a change in the heat transfer temperature T_{H} and continues until the steady state is reached.

$$\begin{matrix}\begin{matrix}{T}_{sur} - {T}_{Gf} = \frac{{R}_{2 f}}{{R}_{1} + {R}_{2 f}} \frac{1}{1 + {sC}_{1} {R}_{1} {R}_{2 f} / ( {R}_{1} + {R}_{2 f} )} ( {T}_{H} - {T}_{Gf} ) \\ = \frac{{k}_{Gf}}{1 + s {τ}_{Gf}} ( {T}_{H} - {T}_{Gf} )\end{matrix} & ( 3 ) \\ {T}_{sur} = \frac{{k}_{Gf}}{1 + s {τ}_{Gf}} ( {T}_{H} - {T}_{Gf} ) + {T}_{Gf} & ( 4 )\end{matrix}$$

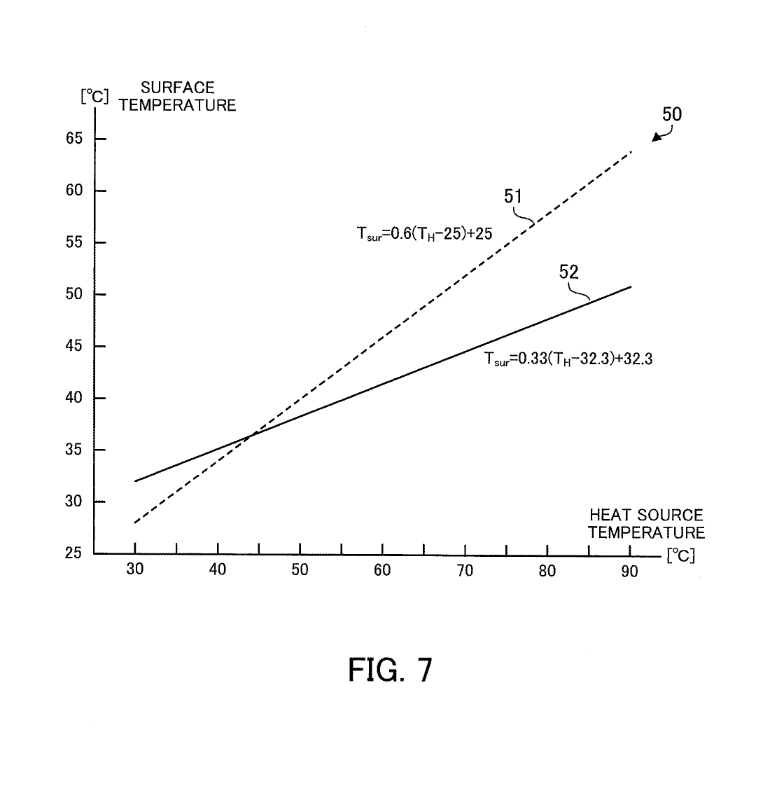

FIG. 7 is a graph representing an example of relationship between heat source temperature and surface temperature.

A human body including palms and fingers includes a skin layer and a muscle layer. The skin layer has a thermal conductivity of λ_{f1}=0.42 [W/mK]. The muscle layer has a thermal conductivity of λ_{f2}=0.50 [W/mK]. For the thermal conductivity λ_{f1} and λ_{f2}, please see, for example, the following document: Paolo Bernardi, Marta Cavagnaro, Stefano Pisa and Emanuele Piuzzi, “Specific Absorption Rate and Temperature Increases in the Head of a Cellular-Phone User,” IEEE Transactions on Microwave Theory and Techniques, Vol. 48, No. 7, July 2000. In addition, the skin layer has a thickness of x₁=0.8×10⁻² [m] and the muscle layer has a thickness of x₂=1.6×10⁻² [m]. For the thickness x₁ and x₂, please see, for example, the following document: Liang-Tseng Fan, Fu-Tong HSU and Ching-Lai Hwang, “A Review on Mathematical Models of the Human Thermal System,” IEEE Transactions on Bio-medical Engineering, Vol. BME-18, No. 3, May 1971.

Therefore, the heat transfer rate h_{f} of human body satisfies the relationship, 1/h_{f}=x₁/λ_{f1}+x₂/λ_{f2}, and the heat transfer rate h_{f} is calculated as h_{f}=19.6 [W/m²K]. On the other hand, air has a thermal conductivity of λₐ=0.0257 [W/mK] and a heat transfer rate of hₐ=7 [W/m²K]. As seen from the above, the heat transfer rate h_{f} of human body is approximately three times as high as the heat transfer rate hₐ of air, and the thermal resistance R_{2f} of human body is approximately ⅓ of the thermal resistance R₂ₐ of air. Therefore, the thermal resistance R_{2f} is approximated as R_{2f}=R₂ₐ/3.

The graph 50 represents relationship between the heat source temperature T_{H} and the surface temperature Tₛᵤᵣ in a steady state. A straight line 51 represents relationship between the heat source temperature T_{H} and the surface temperature Tₛᵤᵣ in the case where air surrounds the housing 101, that is, in the case of the thermal network model 30. A straight line 52 represents relationship between the heat source temperature T_{H} and the surface temperature Tₛᵤᵣ in the case where a human body surrounds the housing 101, that is, in the case of the thermal network model 40.

The straight line 51 is represented by an equation, Tₛᵤᵣ=0.6(T_{H}−25)+25 [° C.]. Here, it is assumed that the heat transfer coefficient k_{Ga} is k_{Ga}=R₂ₐ/(R₁+R₂ₐ)=0.6 and the reference location temperature T_{Ga}, which is the ambient temperature, is T_{Ga}=25 [° C.]. Since the steady state is assumed, the variable s is s=0. The straight line 52 is represented by an equation, Tₛᵤᵣ=0.33(T_{H}−32.3)+32.3 [° C.]. Here, it is assumed that the heat transfer coefficient k_{Gf} is k_{Gf}=R_{2f}/(R₁+R_{2f})=R₂ₐ÷3/(R₁+R₂ₐ÷3)=0.33 and the reference location temperature T_{Gf} that is palm temperature is T_{Gf}=32.3 [° C.]. When the heat source temperature T_{H} exceeds 44 [° C.] under these conditions, the surface temperature Tₛᵤᵣ in the case where the user holds the portable terminal apparatus 100 in his/her hand becomes lower than the surface temperature Tₛᵤᵣ in the case where the user does not hold it.

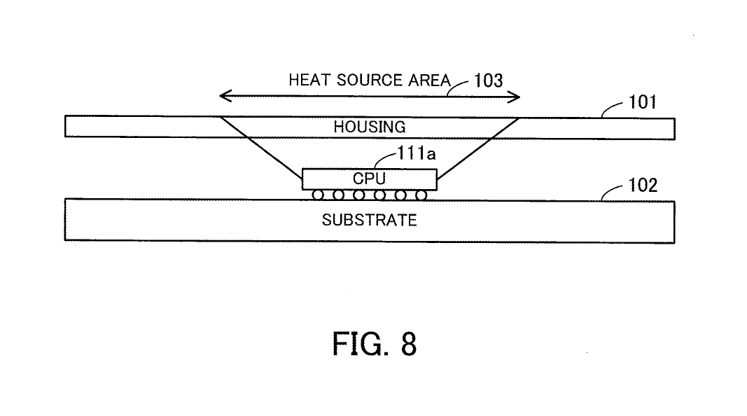

FIG. 8 illustrates an example of a heat source area.

A rise in surface temperature due to generation of heat by the CPU 111a does not occur uniformly in the entire surface of the housing, but locally occurs depending on the location of the CPU 111a. Therefore, when a human body touches the housing surface, the touching has a different impact on the surface temperature depending on the touched position. In the second embodiment, a heat source area 103 is defined on the housing surface according to the location of the CPU 111a, and it is expected that the surface temperature lowers when a human body touches the heat source area 103, and the surface temperature does not lower when the human body touches the outside of the heat source area 103.

It is assumed that a material with isotropic thermal conductivity is used as a heat transfer medium between the CPU 111a and the housing surface. In this case, heat from the CPU 111a spreads over an area of size proportional to the distance from the CPU 111a. In the second embodiment, the heat source area 103 is defined as an area in which its center is just above the center of the CPU 111a and the length of its each side is a value obtained by adding the thickness of the housing 101 to the length of one side of the CPU 111a. The heat source area 103 is previously defined based on the location of the CPU 111a that is a heat source.

The following describes a method for estimating surface temperature Tₛᵤᵣ from sensor temperature Tₛ measured by the temperature sensor 118a and reference location temperature T_{G} measured by the temperature sensor 118b.

Heat from the CPU 111a reaches the temperature sensor 118a though the substrate 102. Since the heat gradually propagates from the CPU 111a to the temperature sensor 118a, a transient response occurs in the sensor temperature Tₛ measured by the temperature sensor 118a. In addition, the heat from the CPU 111a reaches the surface of the housing 101. Since the heat gradually propagates from the CPU 111a to the surface of the housing 101, a transient response occurs in the surface temperature Tₛᵤᵣ of the housing 101.

Tₛ−T_{G} and T_{H}−T_{G} have relationship represented by expression (5). The transfer function H(s) is a transfer function in frequency domain, which converts the relative temperature T_{H}−T_{G} of the CPU 111a into the relative temperature T_{S}−T_{G} of the temperature sensor 118a. The transfer function H(s) includes the variable s, heat transfer coefficient k_{H}, and thermal time constant T_{H} in the frequency domain. The heat transfer coefficient k_{H} is a heat transfer coefficient between the CPU 111a and the temperature sensor 118a. The thermal time constant T_{H} is a thermal time constant between the CPU 111a and the temperature sensor 118a. The heat transfer coefficient k_{H} and the thermal time constant τ_{H} are determined by the design apparatus 200. In this connection, the temperature measured by the temperature sensor 118b is taken as the reference location temperature T_{G}, on the premise that the temperature sensor 118b is sufficiently apart from the heat source.

$${T}_{s} - {T}_{G} = H ( s ) ( {T}_{H} - {T}_{G} ) where H ( s ) = \frac{{k}_{H}}{1 + s {τ}_{H}} \qquad ( 5 )$$

Tₛᵤᵣ−T_{G} and T_{H}−T_{G} have relationship represented by expression (6). The transfer function G(s) is a transfer function in frequency domain, which converts the relative temperature T_{H}−T_{G} of the CPU 111a into the relative temperature Tₛᵤᵣ−T_{G} of the housing surface. The transfer function G(s) includes the variable s, heat transfer coefficient k_{G}, and thermal time constant T_{G} in the frequency domain. The heat transfer coefficient k_{G} is a heat transfer coefficient between the CPU 111a and the housing surface. The thermal time constant T_{G} is a thermal time constant between the CPU 111a and the housing surface. The heat transfer coefficient k_{G} and the thermal time constant τ_{G} are determined by the design apparatus 200.

$${T}_{sur} - {T}_{G} = G ( s ) ( {T}_{H} - {T}_{G} ) where G ( s ) = \frac{{k}_{G}}{1 + s {τ}_{G}} \qquad ( 6 )$$

The surface temperature Tₛᵤᵣ of the housing 101 is calculated using the expressions (5) and (6) as represented by expression (7). That is, the surface temperature Tₛᵤᵣ is estimated from the sensor temperature Tₛ and the reference location temperature T_{G}. The heat transfer coefficient k_{H} and thermal time constant T_{H} included in the transfer function H(s) do not depend on whether a human body touches the heat source area 103 or not. However, the heat transfer coefficient k_{G} and thermal time constant T_{G} included in the transfer function G(s) depend on whether a human body touches the heat source area 103 or not. In the case where a human body does not touch the heat source area 103, the heat transfer coefficient k_{G} is k_{G}=k_{Ga} and the thermal time constant T_{G} is τ_{G}=τ_{Ga}. In the case where a human body touches the heat source area 103, the heat transfer coefficient k_{G} is k_{G}=k_{Gf} and the thermal time constant τ_{G} is τ_{G}=τ_{Gf}.

$${T}_{sur} = \frac{G ( s )}{H ( s )} ( {T}_{s} - {T}_{G} ) + {T}_{G} \qquad ( 7 )$$

The above expression (7) includes a computation in the frequency domain. On the other hand, actually measured sensor temperature Tₛ and reference location temperature T_{G} are discrete time series data. The surface temperature Tₛᵤᵣ(t) at a time t is calculated as represented by expression (8). The expression (8) is a difference equation obtained by transforming the equation (7) using the inverse Laplace transform, and represents a computation in time domain. In this connection, the difference equation represented by the expression (8) is applied to the case where a human body does not touch the heat source area 103.

$${T}_{sur} ( t ) = {a}_{0 a} ( {T}_{s} ( t ) - {T}_{G} ( t ) ) + {a}_{1 a} ( {T}_{s} ( t - Δ t ) - {T}_{G} ( t - Δ t ) ) - {b}_{1 a} ( {T}_{sur} ( t - Δ t ) - {T}_{G} ( t - Δ t ) ) + {T}_{G} ( t ) \qquad ( 8 )$$

For calculating the surface temperature Tₛᵤᵣ(t), the relative temperature Tₛ(t)−T_{G}(t) of the temperature sensor 118a at the time t and the reference location temperature T_{G}(t) at the time t are used. In addition to these, for calculating the surface temperature Tₛᵤᵣ(t), the relative temperature Tₛ(t−Δt)−T_{G}(t−Δt) of the temperature sensor 118a at a time Δt earlier and the relative temperature Tₛᵤᵣ(t−Δt)−T_{G}(t−Δt) of the housing surface at the time Δt earlier are used. The relative temperature of the temperature sensor 118a at the time Δt earlier and the relative temperature of the housing surface at the time Δt earlier are delay data stored at the previous measurement. Δt indicates the time interval for calculating the surface temperature Tₛᵤᵣ(t) and, for example, is set to Δt=10 [seconds].

In the case where a human body does not touch the heat source area 103, a weight coefficient a₀ₐ is given to the relative temperature of the temperature sensor 118a at the time t. A weight coefficient a₁ₐ is given to the relative temperature of the temperature sensor 118a at the time Δt earlier. A weight coefficient b₁ₐ is given to the relative temperature of the housing surface at the time Δt earlier. The coefficients a₀ₐ, a₁ₐ, and b₁ₐ are defined using the heat transfer coefficients k_{H} and k_{Ga}, thermal time constants τ_{H} and τ_{Ga}, and time Δt, as represented by expression (9).

$${a}_{0 a} = \frac{{k}_{Ga}}{{k}_{H}} \frac{Δ t + 2 {τ}_{H}}{Δ t + 2 {τ}_{Ga}} \\ {a}_{1 a} = \frac{{k}_{Ga}}{{k}_{H}} \frac{{ }_{ } Δ t - 2 {τ}_{H}}{Δ t + 2 {τ}_{Ga}} \\ {b}_{1 a} = \frac{Δ t - 2 {τ}_{Ga}}{Δ t + 2 {τ}_{Ga}} \qquad ( 9 )$$

In the case where a human body touches the heat source area 103, the surface temperature Tₛᵤᵣ(t) at the time t is calculated as represented by expression (10). A weight coefficient a_{0f} is given to the relative temperature of the temperature sensor 118a at the time t. A weight coefficient a_{1f} is given to the relative temperature of the temperature sensor 118a at the time Δt earlier. A weight coefficient b_{1f} is given to the relative temperature of the housing surface at the time Δt earlier. The coefficients a_{0f}, a_{1f}, and b_{1f} are defined using the heat transfer coefficients k_{H} and k_{Gf}, thermal time constants τ_{H} and τ_{Gf}, and time Δt, as represented by expression (11).

$$\begin{matrix}{T}_{sur} ( t ) = {a}_{0 f} ( {T}_{s} ( t ) - {T}_{G} ( t ) ) + {a}_{1 f} ( {T}_{s} ( t - Δ t ) - {T}_{G} ( t - Δ t ) ) - {b}_{1 f} ( {T}_{sur} ( t - Δ t ) - {T}_{G} ( t - Δ t ) ) + {T}_{G} ( t ) & ( 10 ) \\ {a}_{0 f} = \frac{{k}_{Gf}}{{k}_{H}} \frac{Δ t + 2 {τ}_{H}}{Δ t + 2 {τ}_{Gf}} \\ {a}_{1 f } = \frac{{k}_{Gf}}{{k}_{H}} \frac{Δ t - 2 {τ}_{H}}{Δ t + 2 {τ}_{Gf}} \\ {b}_{1 f} = \frac{Δ t - 2 {τ}_{Gf}}{Δt + 2 {τ}_{Gf}} & ( 11 )\end{matrix}$$

The following describes functions of the portable terminal apparatus 100 and design apparatus 200.

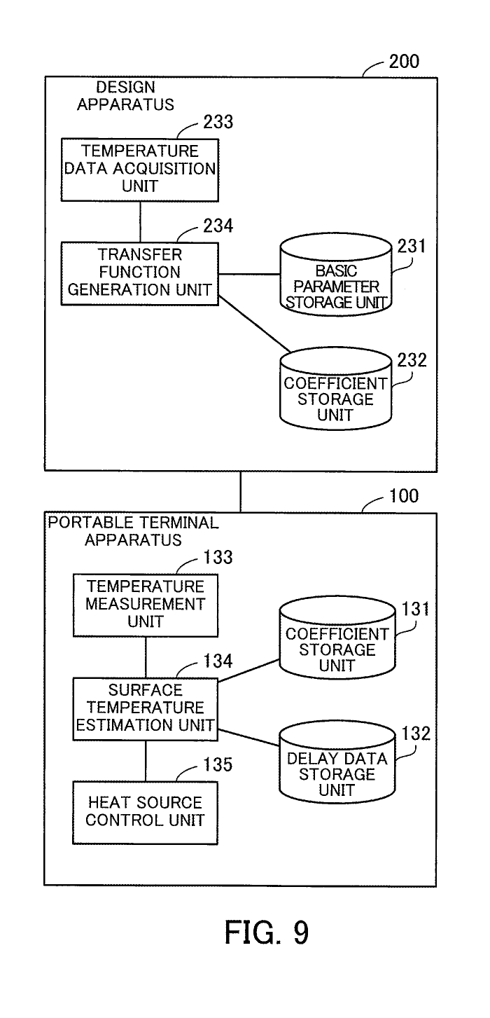

FIG. 9 is a block diagram illustrating an example of functions of the portable terminal apparatus and design apparatus.

The portable terminal apparatus 100 includes a coefficient storage unit 131, a delay data storage unit 132, a temperature measurement unit 133, a surface temperature estimation unit 134, and a heat source control unit 135. The coefficient storage unit 131 and delay data storage unit 132 are implemented by using the RAM 112 or non-volatile memory 113, for example. The temperature measurement unit 133, surface temperature estimation unit 134, and heat source control unit 135 are implemented by the CPU 111a or 111b running programs, for example.

The coefficient storage unit 131 stores therein a coefficient table that contains coefficients represented by the above expressions (9) and (11). The coefficient table may be stored in the coefficient storage unit 131 at the time of manufacturing or delivery of the portable terminal apparatus 100. Alternatively, the coefficient table may be stored in the recording medium 122, which is then distributed to the portable terminal apparatus 100. The coefficient table may be distributed from a server apparatus to the portable terminal apparatus 100 over a wireless network. The delay data storage unit 132 stores therein a delay data table that contains delay data represented by the expressions (8) and (10).

The temperature measurement unit 133 periodically obtains the sensor temperature Tₛ from the temperature sensor 118a and the reference location temperature T_{G} from the temperature sensor 118b at intervals of Δt. The surface temperature estimation unit 134 periodically estimates the surface temperature Tₛᵤᵣ of the housing 101 at intervals of Δt. More specifically, the surface temperature estimation unit 134 obtains the latest sensor temperature T_{S} and reference location temperature T_{G} from the temperature measurement unit 133. The surface temperature estimation unit 134 then calculates the surface temperature Tₛᵤᵣ on the basis of the latest sensor temperature Tₛ and reference location temperature T_{G}, the coefficients stored in the coefficient storage unit 131, and the delay data stored in the delay data storage unit 132. The surface temperature estimation unit 134 updates the delay data stored in the delay data storage unit 132 on the basis of the calculated surface temperature Tₛᵤᵣ.

The heat source control unit 135 controls the CPU 111a, which is a heat source, on the basis of the surface temperature Tₛᵤᵣ calculated by the surface temperature estimation unit 134. The heat source control unit 135 compares the calculated surface temperature Tₛᵤᵣ with a prescribed threshold. The threshold is a preset temperature acceptable for a user to touch the portable terminal apparatus 100. If the surface temperature Tₛᵤᵣ is higher than or equal to the threshold, the heat source control unit 135 lowers the maximum frequency of the CPU 111a by one step. This means setting the upper limit for the clock frequency of the CPU 111a to that maximum frequency, irrespective of the physical upper limit. By doing so, the generation of heat by the CPU 111a under heavy load is reduced. If the surface temperature Tₛᵤᵣ is lower than the threshold, the heat source control unit 135 increases the maximum frequency of the CPU 111a by one step. By doing so, the computational performance of the CPU 111a is improved.

The design apparatus 200 includes a basic parameter storage unit 231, a coefficient storage unit 232, a temperature data acquisition unit 233, and a transfer function generation unit 234. The basic parameter storage unit 231 and coefficient storage unit 232 are implemented by using the RAM 212 or HDD 213, for example. The temperature data acquisition unit 233 and transfer function generation unit 234 are implemented by the CPU 211 running programs, for example.

The basic parameter storage unit 231 stores therein a basic parameter table that contains basic parameters included in the right-hand sides of the expressions (9) and (11). The basic parameters include heat transfer coefficients k_{H}, k_{Ga}, and k_{Gf} and thermal time constants τ_{M}, τ_{Ga}, and τ_{Gf}. These basic parameters are determined by the design apparatus 200. The coefficient storage unit 232 stores therein the same coefficient table as the coefficient storage unit 131 of the portable terminal apparatus 100. These coefficients are calculated from the basic parameters with the expressions (9) and (11). The design apparatus 200 may store the coefficient table in the non-volatile memory 113 of the portable terminal apparatus 100. Alternatively, the design apparatus 200 may write the coefficient table to the recording medium 122, which is then distributed. The design apparatus 200 may send the coefficient table over the network 224.

In this connection, the design apparatus 200 may provide the portable terminal apparatus 100 with the basic parameters of the right-hand sides of the expressions (9) and (11), instead of the coefficients of the left-hand sides thereof. In this case, the portable terminal apparatus 100 stores a basic parameter table. The portable terminal apparatus 100 may calculate coefficients from the basic parameters every time or before surface temperature is estimated. In addition, the portable terminal apparatus 100 may estimate the surface temperature from the basic parameters directly.

The temperature data acquisition unit 233 obtains temperature data measured using a real or sample device of the portable terminal apparatus 100. The temperature data may be entered to the design apparatus 200 by the user of the design apparatus 200. Alternatively, the temperature data may be obtained directly from the portable terminal apparatus 100 or a measurement device connected to the design apparatus 200.

The transfer function generation unit 234 determines the values of the basic parameters included in the transfer functions using the temperature data obtained from the temperature data acquisition unit 233 with a fitting method, such as the least-squares method. The transfer function generation unit 234 stores the determined values of the basic parameters in the basic parameter storage unit 231. Then, the transfer function generation unit 234 calculates the values of the coefficients included in the expressions (8) and (10) from the values of the basic parameters. The transfer function generation unit 234 stores the calculated values of the coefficients in the coefficient storage unit 232.

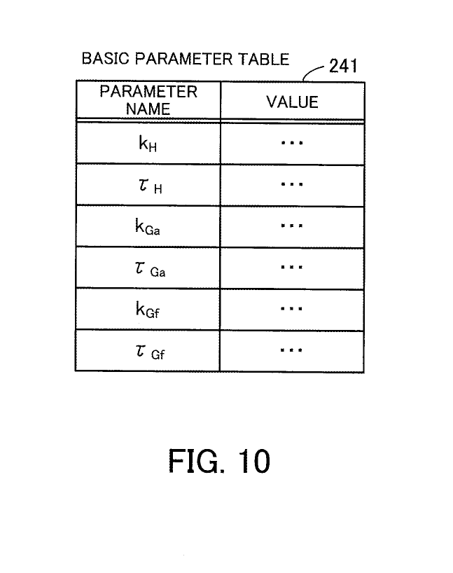

FIG. 10 illustrates an example of a basic parameter table.

The basic parameter table 241 is stored in the basic parameter storage unit 231. The basic parameter table 241 contains a combination of parameter name and value for each basic parameter. The basic parameters include a heat transfer coefficient k_{H}, thermal time constant τ_{H}, heat transfer coefficient k_{Ga}, thermal time constant τ_{Ga}, heat transfer coefficient k_{Gf}, and thermal time constant τ_{Gf}. The basic parameters are determined as follows.

First, while changing the load on the CPU 111a stepwise in a state where a human body does not touch a housing surface, the surface temperature Tₛᵤᵣ, heat source temperature T_{H}, sensor temperature Tₛ, and reference location temperature T_{G} are measured at each time point. The heat transfer coefficient k_{H} is determined with Tₛ−T_{G}=k_{H}(T_{H}−T_{G}) using the sensor temperature Tₛ, heat source temperature T_{H}, and reference location temperature T_{G} in a steady state. In addition, the heat transfer coefficient k_{Ga} is determined with Tₛᵤᵣ−T_{G}=k_{Ga}(T_{H}−T_{G}) using the surface temperature Tₛᵤᵣ, heat source temperature T_{H}, and reference location temperature T_{G} in the steady state. Then, the thermal time constant τ_{H} in H(s) is determined with L(Tₛ−T_{G})=H(s)L(T_{H}−T_{G}) using the sensor temperature Tₛ, heat source temperature T_{H}, and reference location temperature T_{G} in transient response. L(•) denotes the Laplace transform. In addition, the thermal time constant τ_{Ga} in G(s) is determined with L(Tₛᵤᵣ−T_{G})=G(s)L(T_{H}−T_{G}) using the surface temperature Tₛᵤᵣ, heat source temperature T_{H}, and reference location temperature T_{G} in the transient response.

Next, while changing the load on the CPU 111a stepwise in a state where a human body touches the housing surface, the surface temperature Tₛᵤᵣ, heat source T_{H}, and reference location temperature T_{G} are measured at each time point. The heat transfer coefficient k_{Gf} is determined with Tₛᵤᵣ−T_{G}=k_{Gf}(T_{H}−T_{G}) using the surface temperature Tₛᵤᵣ, heat source temperature T_{H}, and reference location temperature T_{G} in the steady state. Then, the thermal time constant T_{Gf} in G(s) is determined with L(Tₛᵤᵣ−T_{G})=G(s)L(T_{H}−T_{G}) using the surface temperature Tₛᵤᵣ, heat source temperature T_{H}, and reference location temperature T_{G} in the transient response.

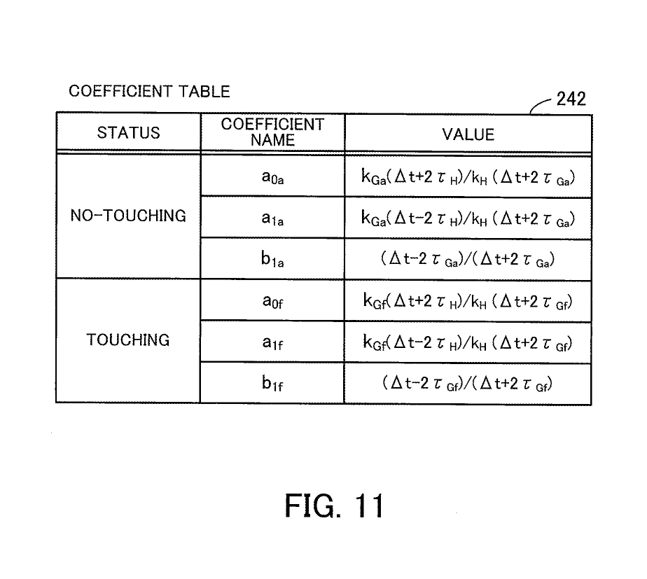

FIG. 11 illustrates an example of a coefficient table.

The coefficient table 242 is stored in the coefficient storage units 131 and 232. The coefficient table 242 includes the following items: Status, Coefficient Name, and Value. The Status item contains “no-touching” or “touching.” The Coefficient Name item contains coefficients a₀ₐ, a₁ₐ, and b₁ₐ with respect to the “no-touching” state and coefficients a_{0f}, a_{1f}, and b_{1f} with respect to the “touching” state. The values of the coefficients a₀ₐ, a₁ₐ, and b₁ₐ are calculated from the heat transfer coefficients k_{H} and k_{Ga}, thermal time constants T_{H} and τ_{Ga}, and time Δt with the expression (9). The values of the coefficients a_{0f}, a_{1f}, and b_{1f} are calculated from the heat transfer coefficients k_{H} and k_{Gf}, thermal time constants τ_{H} and τ_{Gf}, and time Δt with the expression (11).

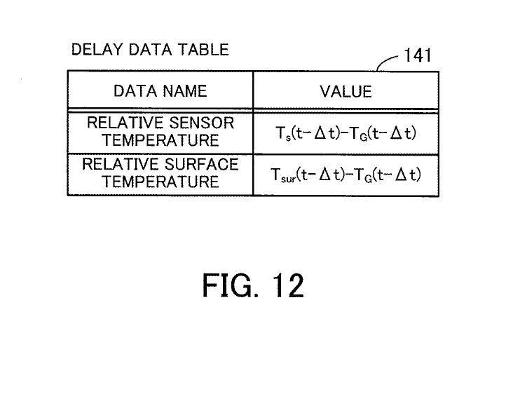

FIG. 12 illustrates an example of a delay data table.

The delay data table 141 is stored in the delay data storage unit 132. The delay data table 141 contains combinations of data name and value. The delay data includes “relative sensor temperature” and “relative surface temperature.” The relative sensor temperature is a difference between sensor temperature Tₛ(t−Δt) measured by the temperature sensor 118a at a time Δt earlier and reference location temperature T_{G}(t−Δt) measured by the temperature sensor 118b at the time Δt earlier. The relative surface temperature is a difference between surface temperature Tₛᵤᵣ(t−Δt) estimated at the time Δt earlier and reference location temperature T_{G}(t−Δt) measured at the time Δt earlier. The values in the delay data table 141 are updated at intervals of Δt.

The following describes how the portable terminal apparatus 100 and design apparatus 200 operate.

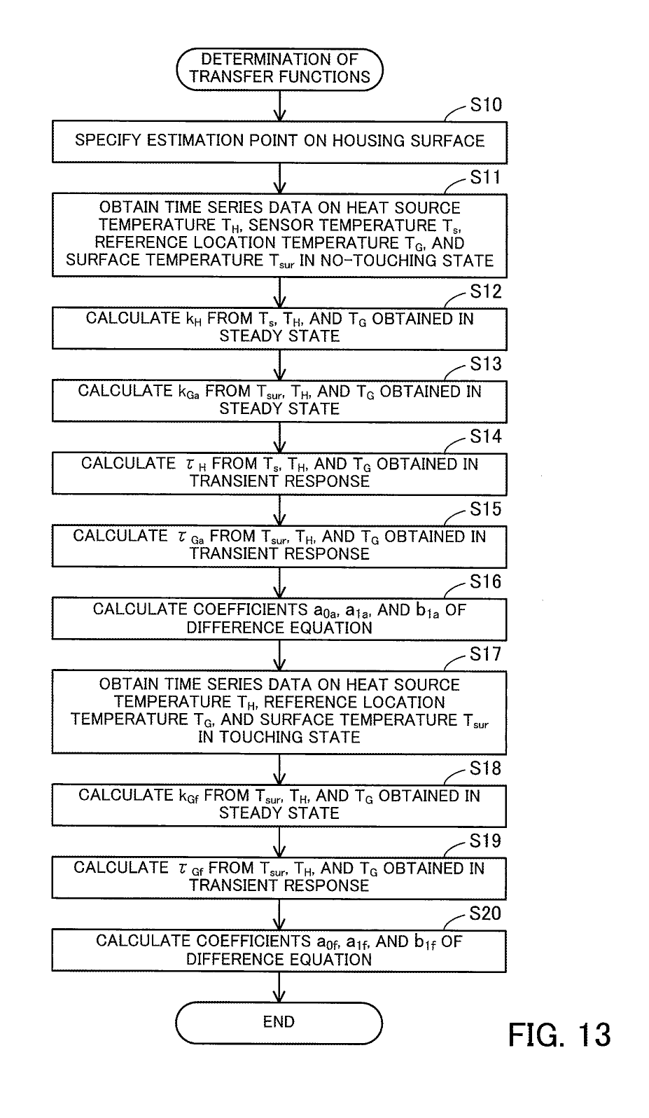

FIG. 13 is a flowchart illustrating a process of determining transfer functions.

(S10) The transfer function generation unit 234 is notified of a location (estimation point) specified on the housing surface for estimating surface temperature Tₛᵤᵣ by the user of the design apparatus 200. The specified estimation point is a point that is within the heat source area 103 and is expected to have the highest temperature.

(S11) The temperature data acquisition unit 233 obtains time series data on the heat source temperature T_{H}, sensor temperature Tₛ, reference location temperature T_{G}, and surface temperature Tₛᵤᵣ that are measured while changing the load on the CPU 111a in a state where a human body does not touch the heat source area 103.

(S12) The transfer function generation unit 234 extracts data indicating a steady state from the time series data on the sensor temperature Tₛ, heat source temperature T_{H}, and reference location temperature T_{G}, and calculates the heat transfer coefficient k_{H} with a fitting algorithm, such as the least-squares method, in time domain. The transfer function generation unit 234 registers the calculated heat transfer coefficient k_{H} in the basic parameter table 241.

(S13) The transfer function generation unit 234 extracts data indicating the steady state from the time series data on the surface temperature Tₛᵤᵣ, heat source temperature T_{H}, and reference location temperature T_{G}, and calculates the heat transfer coefficient k_{Ga} with a fitting algorithm, such as the least-squares method, in the time domain. The transfer function generation unit 234 registers the calculated heat transfer coefficient k_{Ga} in the basic parameter table 241.

(S14) The transfer function generation unit 234 extracts data indicating a transient response from the time series data on the sensor temperature Tₛ, heat source temperature T_{H}, and reference location temperature T_{G}, and calculates the thermal time constant τ_{H} with a fitting algorithm, such as the least-squares method, in frequency domain. The transfer function generation unit 234 registers the calculated thermal time constant τ_{H} in the basic parameter table 241.

(S15) The transfer function generation unit 234 extracts data indicating the transient response from the time series data on the surface temperature Tₛᵤᵣ, heat source temperature T_{H}, and reference location temperature T_{G}, and calculates the thermal time constant τ_{Ga} with a fitting algorithm, such as the least-squares method, in the frequency domain. The transfer function generation unit 234 registers the calculated thermal time constant τ_{Ga} in the basic parameter table 241.

(S16) The transfer function generation unit 234 calculates the coefficients a₀ₐ, a₁ₐ, and b₁ₐ of the difference equation from the heat transfer coefficients k_{H} and k_{Ga} and thermal time constants T_{H} and T_{Ga}. The transfer function generation unit 234 registers the calculated coefficients a₀ₐ, a₁ₐ, and b₁ₐ in the coefficient table 242.

(S17) The temperature data acquisition unit 233 obtains time series data on the heat source temperature T_{H}, reference location temperature T_{G}, and surface temperature Tₛᵤᵣ that are measured while changing the load on the CPU 111a in a state where a human body touches the heat source area 103.

(S18) The transfer function generation unit 234 extracts data indicating a steady state from the time series data on the surface temperature Tₛᵤᵣ, heat source temperature T_{H}, and reference location temperature T_{G}, and calculates the heat transfer coefficient k_{Gf} with a fitting algorithm, such as the least-squares method, in the time domain. The transfer function generation unit 234 registers the calculated heat transfer coefficient k_{Gf} in the basic parameter table 241.

(S19) The transfer function generation unit 234 extracts data indicating a transient response from the time series data on the surface temperature Tₛᵤᵣ, heat source temperature T_{H}, and reference location temperature T_{G}, and calculates the thermal time constant τ_{Gf} with a fitting algorithm, such as the least-squares method, in the frequency domain. The transfer function generation unit 234 registers the calculated thermal time constant τ_{Gf} in the basic parameter table 241.

(S20) The transfer function generation unit 234 calculates the coefficients a_{0f}, a_{1f}, and b_{1f} of the difference equation from the heat transfer coefficients k_{H} and k_{Gf} and thermal time constants T_{H} and T_{Gf}. The transfer function generation unit 234 registers the calculated coefficients a_{0f}, a_{1f}, and b_{1f} in the coefficient table 242.

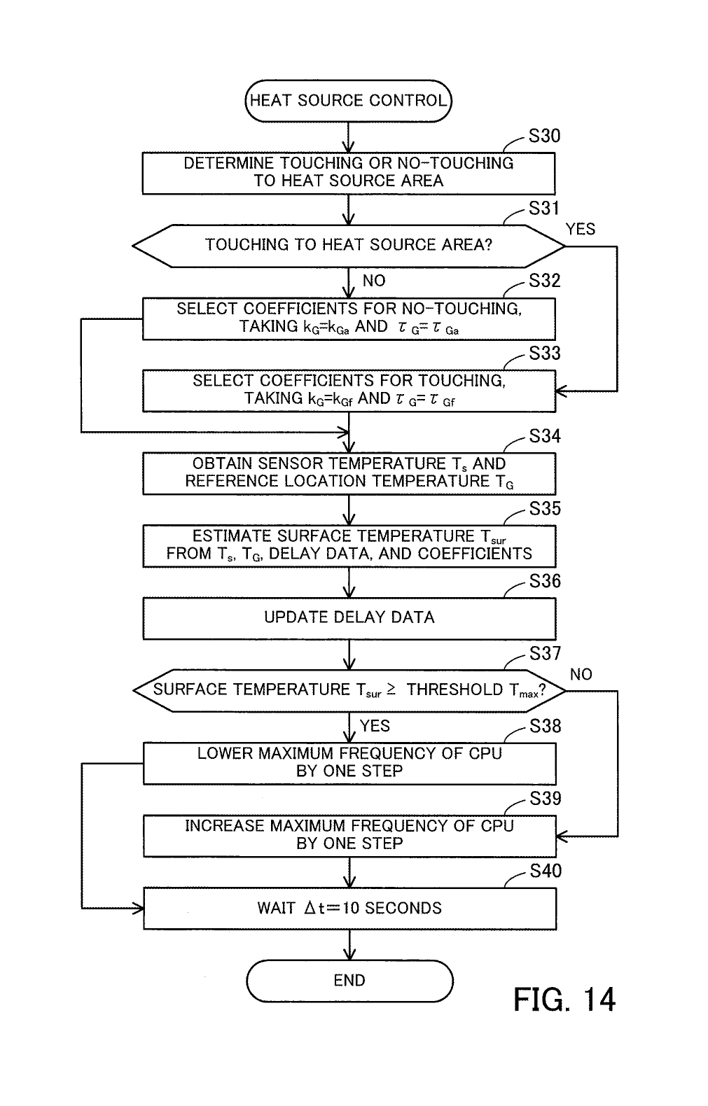

FIG. 14 is a flowchart illustrating a process of controlling a heat source according to the second embodiment.

(S30) The surface temperature estimation unit 134 waits for a touch notification from the touch sensor 119b. The touch notification is issued when a human body or another touches the back surface of the housing 101. The touch notification includes the coordinates of a touched position detected by the touch sensor 119b. For example, the surface temperature estimation unit 134 waits a prescribed time (for example, one second) for a touch notification after the heat source control starts. When receiving a touch notification from the touch sensor 119b, the surface temperature estimation unit 134 determines whether the touched position is within the heat source area 103. The coordinates of the heat source area 103 are previously registered in the non-volatile memory 113 of the portable terminal apparatus 100, for example. In this way, the surface temperature estimation unit 134 determines whether the touching has been done to the heat source area 103.

(S31) The surface temperature estimation unit 134 determines whether the touching has been done to the heat source area 103. If the touching has been done to the heat source area 103, the process proceeds to step S33. If the touching has not been done to the heat source area 103, that is, if no touching to the back surface of the housing 101 has been detected or if the touched position is outside the heat source area 103, the process proceeds to step S32.

(S32) The surface temperature estimation unit 134 takes the heat transfer coefficient k_{G} as k_{G}=k_{Ga} and the thermal time constant τ_{G} as T_{G}=τ_{Ga} and selects the coefficients a₀ₐ, a₁ₐ, and b₁ₐ corresponding to the no-touching state from the coefficient table 242.

(S33) The surface temperature estimation unit 134 takes the heat transfer coefficient k_{G} as k_{G}=k_{Gf} and the thermal time constant τ_{G} as T_{G}=τ_{Gf} and selects the coefficients a_{0f}, a_{1f}, and b_{1f} corresponding to the touching state from the coefficient table 242.

(S34) The temperature measurement unit 133 obtains the sensor temperature Tₛ from the temperature sensor 118a, and obtains the reference location temperature T_{G} from the temperature sensor 118b. In this connection, step S34 may be executed in parallel to steps S30 to S33.

(S35) The surface temperature estimation unit 134 extracts the relative sensor temperature and relative surface temperature from the delay data table 141. The surface temperature estimation unit 134 estimates the current surface temperature Tₛᵤᵣ using the currently obtained sensor temperature Tₛ and reference location temperature T_{G}, the extracted delay data, and the coefficients selected at step S32 or S33. If the touching has not been done to the heat source area 103, the surface temperature estimation unit 134 estimates the surface temperature Tₛᵤᵣ with the difference equation of the expression (8). If the touching has been done to the heat source area 103, the surface temperature estimation unit 134 estimates the surface temperature Tₛᵤᵣ with the difference equation of the expression (10).

(S36) The surface temperature estimation unit 134 calculates a difference between the currently obtained sensor temperature Tₛ and reference location temperature T_{G} as the current relative sensor temperature, and a difference between the currently obtained surface temperature Tₛᵤᵣ and reference location temperature T_{G} as the current relative surface temperature. The surface temperature estimation unit 134 replaces the previous relative sensor temperature and relative surface temperature registered in the delay data table 141 with the currently obtained values, to thereby update the delay data in the delay data table 141.

(S37) The heat source control unit 135 compares the surface temperature Tₛᵤᵣ estimated at step S35 with a threshold Tₘₐₓ. The threshold Tₘₐₓ is registered in advance in the non-volatile memory 113 of the portable terminal apparatus 100, for example. The heat source control unit 135 determines whether or not the surface temperature Tₛᵤᵣ is higher than or equal to the threshold Tₘₐₓ. If the surface temperature Tₛᵤᵣ is higher than or equal to the threshold Tₘₐₓ, the process proceeds to step S38. If the surface temperature Tₛᵤᵣ is lower than the threshold Tₘₐₓ, the process proceeds to step S39.

(S38) The heat source control unit 135 lowers the maximum frequency of the CPU 111a by one step. This imposes a more severe limit on the clock frequency of the CPU 111a. By doing so, the generation of heat by the CPU 111a under heavy load is reduced. However, the computational performance of the CPU 111a degrades. In this connection, if the maximum frequency of the CPU 111a has already reached a physical lower limit, the heat source control unit 135 maintains the current maximum frequency of the CPU 111a.

(S39) The heat source control unit 135 increases the maximum frequency of the CPU 111a by one step. This relaxes the limit on the clock frequency of the CPU 111a. Thereby, the computational performance of the CPU 111a under heavy load is improved. However, more heat is generated by the CPU 111a. In this connection, if the maximum frequency has already reached a physical upper limit, the heat source control unit 135 maintains the current maximum frequency of the CPU 111a.

(S40) The surface temperature estimation unit 134 waits Δt=10 [seconds]. When the time Δt passes, steps S30 to S40 are executed again.

In this connection, there are cases where a user's hand touches the portable terminal apparatus 100, not directly but indirectly, such as a case where the user with gloves on his/her hands operates the portable terminal apparatus 100 and a case where the portable terminal apparatus 100 has a cover thereon. A material existing between the user's hand and the portable terminal apparatus 100 may have a higher thermal resistance than human body and a lower thermal resistance than air. For example, yarn, which is used for gloves, includes a lot of air, so that the gloves have higher thermal resistance than human body and lower thermal resistance than air. Therefore, the surface temperature obtained when the user with gloves touches the portable terminal apparatus 100 is higher than that obtained when the user without gloves touches the portable terminal apparatus 100, and is lower than that obtained when the user does not touch the portable terminal apparatus 100.

Therefore, the case where user's hands do not touch the portable terminal apparatus 100 directly may be regarded as a case where the user's hands do not touch the portable terminal, in order to reduce a risk of calculating an estimated value of surface temperature to be lower than actual temperature. For example, it is considered that, by setting a low sensitivity (detection accuracy) of the touch sensor 119b, touching is not detected if a user's hand does not touch the portable terminal apparatus 100 directly and is apart from the portable terminal apparatus 100. It is preferable that the touch sensor 119b be configured such as not to detect touching if a user with gloves on his/her hands holds the portable terminal apparatus 100. In addition, it is preferable that the touch sensor 119b be configured such as not to detect touching if the user holds the portable terminal apparatus 100 having a cover thereon (i.e., if the user's hand touches the cover).

According to the portable terminal apparatus 100 of the second embodiment, a heat transfer function to be used for the case where a human body does not touch a heat source area and a heat transfer function to be used for the case where a human body touches the heat source area are prepared. Whether touching has been done to the heat source area is determined using a touch sensor provided on the back surface of the housing, and if no touching is detected, the surface temperature is estimated using the former heat transfer function and the measured values obtained by two temperature sensors. If touching is detected, the surface temperature is estimated using the latter heat transfer function and the measured values obtained by the two temperature sensors. Then, the maximum frequency of the CPU is changed according to the estimated surface temperature.

The heat transfer coefficient (k value) in the heat transfer function for the touching state is smaller than that in the heat transfer function for the no-touching state. Therefore, the surface temperature calculated with the heat transfer function for the touching state is lower than that calculated with the heat transfer function for the no-touching state. That is, the surface temperature is estimated, taking into consideration a reduction in the surface temperature due to touching of a human body to the heat source area. This improves the estimation accuracy. Thus, it is possible to reduce a risk of calculating the estimated value of the surface temperature to be higher than actual temperature. It is also possible to reduce a risk of excessively limiting the clock frequency of the CPU. As a result, it is possible to improve the performance of the CPU.

### Third Embodiment

A third embodiment will now be described. Differences from the second embodiment will mainly be described, and the same description as already described in the second embodiment may not be repeated.

A portable terminal apparatus of the third embodiment relaxes the limit on the clock frequency of a CPU by preferentially stopping battery charging, considering that a charging circuit could be a heat source, like a CPU. The portable terminal apparatus of the third embodiment is implemented with the same configuration as the portable terminal apparatus 100 of the second embodiment illustrated in FIGS. 2, 3, 8, 9, 11, and 12. In the following, the third embodiment will be described using the same reference numerals as used in FIGS. 2, 3, 8, 9, 11, and 12.

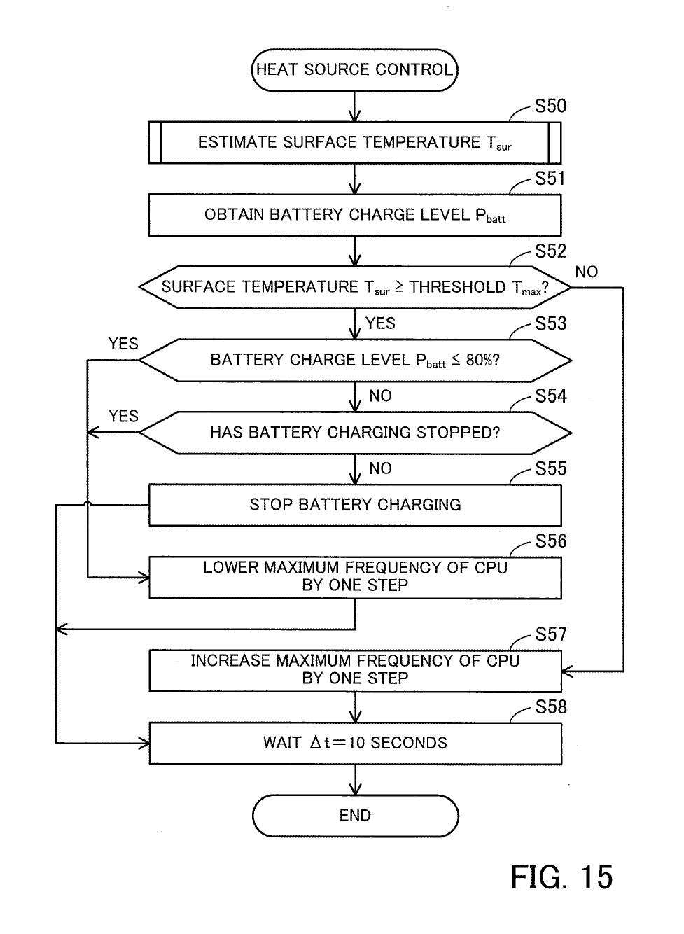

FIG. 15 is a flowchart illustrating a process of controlling a heat source according to the third embodiment.

(S50) A surface temperature estimation unit 134 estimates surface temperature Tₛᵤᵣ. This step is executed in the same way as steps S30 to S36 of the second embodiment.

(S51) A charging circuit 124 measures a battery charge level P_{batt}. A heat source control unit 135 obtains the battery charge level P_{batt} from the charging circuit 124.

(S52) The heat source control unit 135 determines whether or not the estimated surface temperature Tₛᵤᵣ is higher than or equal to a threshold Tₘₐₓ. If the estimated surface temperature Tₛᵤᵣ is higher than or equal to the threshold Tₘₐₓ, the process proceeds to step S53. If the estimated surface temperature Tₛᵤᵣ is lower than the threshold Tₘₐₓ, the process proceeds to step S57.

(S53) The heat source control unit 135 determines whether or not the battery charge level P_{batt} is less than or equal to a threshold. The threshold for the battery charge level is previously set to, for example, 80%. If the battery charge level P_{batt} is less than or equal to the threshold, the process proceeds to step S56. If the battery charge level P_{batt} exceeds the threshold, the process proceeds to step S54.

(S54) The heat source control unit 135 determines whether the charging from the charging circuit 124 to a battery 123 has stopped. If the battery charging has stopped, the process proceeds to step S56. If the battery charging is under progress, then the process proceeds to step S55.

(S55) The heat source control unit 135 stops the battery charging. In this case, the heat source control unit 135 does not need to lower the maximum frequency of the CPU 111a.

(S56) The heat source control unit 135 lowers the maximum frequency of the CPU 111a by one step. However, if the maximum frequency of the CPU 111a has already reached a physical lower limit, the heat source control unit 135 maintains the current maximum frequency of the CPU 111a.

(S57) The heat source control unit 135 increases the maximum frequency of the CPU 111a by one step. However, if the maximum frequency of the CPU 111a has already reached a physical upper limit, the heat source control unit 135 maintains the current maximum frequency of the CPU 111a.

(S58) The surface temperature estimation unit 134 waits Δt=10 [seconds]. When the time Δt passes, steps S50 to S58 are executed again.

The portable terminal apparatus of the third embodiment provides the same effects as that of the second embodiment. In addition, in the third embodiment, if there is a possibility of reducing surface temperature by stopping battery charging, the battery charging is preferentially stopped, and the lowering of the maximum frequency of a CPU is deferred. This approach makes it possible to improve the performance of the CPU.

### Fourth Embodiment

A fourth embodiment will now be described. Differences from the second embodiment will mainly be described, and the same description as already described in the second embodiment may not be repeated.

A portable terminal apparatus of the fourth embodiment is designed to control execution of battery charging according to estimated surface temperature. The control of the battery charging may be exercised, instead of or in addition to the control of a clock frequency of the second embodiment. The portable terminal apparatus of the fourth embodiment is implemented with the same configuration as the portable terminal apparatus 100 of the second embodiment illustrated in FIGS. 2, 3, 8, 9, 11, and 12. In the following, the fourth embodiment will be described using the same reference numerals as used in FIGS. 2, 3, 8, 9, 11, and 12.

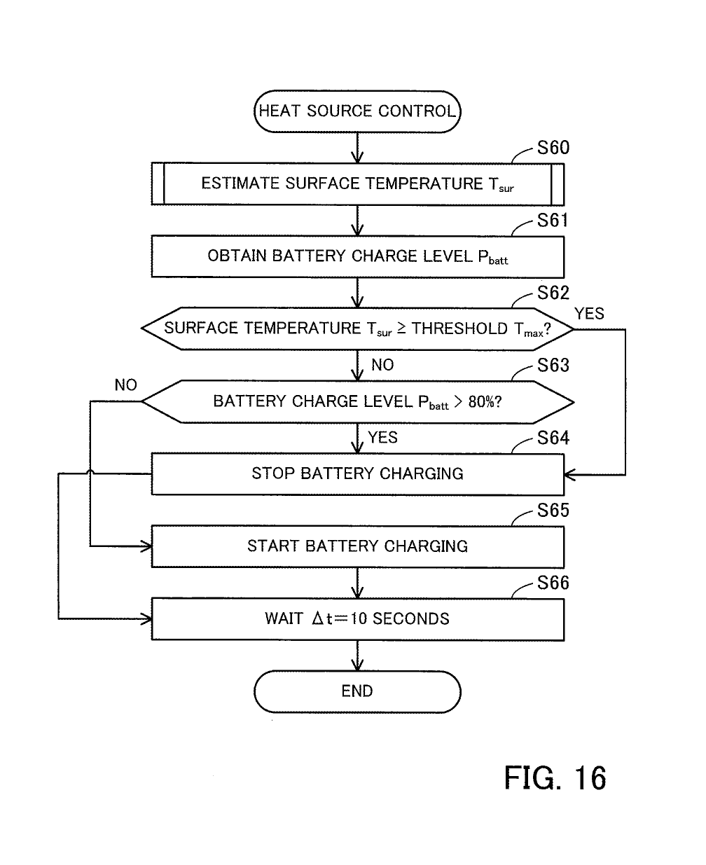

FIG. 16 is a flowchart illustrating a process of controlling a heat source according to the fourth embodiment.

(S60) A surface temperature estimation unit 134 estimates surface temperature Tₛᵤᵣ. This step is executed in the same way as steps S30 to S36 of the second embodiment.

(S61) A charging circuit 124 measures a battery charge level P_{batt}. A heat source control unit 135 obtains the battery charge level P_{batt} from the charging circuit 124.

(S62) The heat source control unit 135 determines whether or not the estimated surface temperature Tₛᵤᵣ is higher than or equal to a threshold Tₘₐₓ. If the estimated surface temperature Tₛᵤᵣ is higher than or equal to the threshold Tₘₐₓ, the process proceeds to step S64. If the estimated surface temperature Tₛᵤᵣ is lower than the threshold Tₘₐₓ, the process proceeds to step S63.

(S63) The heat source control unit 135 determines whether the battery charge level P_{batt} exceeds a threshold. The threshold for the battery charge level is previously set to, for example, 80%. If the battery charge level P_{batt} exceeds the threshold, the process proceeds to step S64. If the battery charge level P_{batt} is less than or equal to the threshold, the process proceeds to step S65.

(S64) The heat source control unit 135 stops the charging from the charging circuit 124 to a battery 123. In this connection, if the battery charging has already stopped, the heat source control unit 135 just maintains this stop state.

(S65) The heat source control unit 135 starts the charging from the charging circuit 124 to the battery 123. In this connection, if the battery charging is already under progress, the heat source control unit 135 just maintains this charging state.

(S66) The surface temperature estimation unit 134 waits Δt=10 [seconds]. When the time Δt passes, steps S60 to S66 are executed again.

In the portable terminal apparatus of the fourth embodiment, if the estimated value of the surface temperature is high, the charging circuit 124 that is a heat source is stopped to thereby reduce the surface temperature. In the case of stopping the charging circuit 124 while the clock frequency of a CPU is limited as in the second embodiment, it is possible to reduce the surface temperature rapidly. This results in reducing the time during which the clock frequency of the CPU is limited, which leads to improving the performance of the CPU.

According to one aspect, it is possible to minimize performance degradation of a processor during temperature control.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A portable electronic device comprising:
a control unit that includes a processor whose clock frequency is variable;
a temperature sensor;
a housing that encases the control unit and the temperature sensor; and
a touch sensor that is able to detect touching to a surface of the housing,
wherein the control unit is configured to:
obtain a measured value of temperature from the temperature sensor;
calculate an estimated value of surface temperature of the housing using the measured value and a first heat transfer model when the touch sensor has not detected the touching, and calculate the estimated value using the measured value and a second heat transfer model when the touch sensor has detected the touching; and
decrease an upper limit for the clock frequency when the estimated value is higher than or equal to a first threshold, and increase the upper limit for the clock frequency when the estimated value is lower than the first threshold.

2. The portable electronic device according to claim 1, wherein:
the first heat transfer model includes a first thermal resistance and a first thermal time constant that characterize heat transfer from the processor to the surface of the housing;
the second heat transfer model includes a second thermal resistance and a second thermal time constant that characterize heat transfer from the processor to the surface of the housing;
the first thermal resistance and the second thermal resistance have different values from each other; and
the first thermal time constant and the second thermal time constant have different values from each other.

3. The portable electronic device according to claim 1, wherein the control unit is further configured to limit an area within which the touch sensor detects the touching, to a specific heat source area corresponding to a location of the processor on the surface of the housing.

4. The portable electronic device according to claim 1, further comprising:
a chargeable battery,
wherein the control unit is further configured to preferentially stop charging to the battery, over the decreasing of the upper limit for the clock frequency, when the estimated value is higher than or equal to the first threshold, a charge level of the battery exceeds a second threshold, and the battery is currently charged.

5. The portable electronic device according to claim 1, further comprising:
a chargeable battery,
wherein the control unit is further configured to limit charging to the battery when the estimated value is higher than or equal to the first threshold.

6. A processor control method comprising:
obtaining, by a portable electronic device, a measured value of temperature from a temperature sensor, the temperature sensor being encased in a housing of the portable electronic device;
calculating, by the portable electronic device, an estimated value of surface temperature of the housing using the measured value and a first heat transfer model when a touch sensor, which is able to detect touching to a surface of the housing, has not detected the touching, and calculating the estimated value using the measured value and a second heat transfer model when the touch sensor has detected the touching; and
decreasing, by the portable electronic device, an upper limit for a clock frequency of a processor encased in the housing when the estimated value is higher than or equal to a threshold, and increasing the upper limit for the clock frequency when the estimated value is lower than the threshold.

7. A non-transitory computer-readable recording medium storing a computer program that causes a computer provided in a portable electronic device to perform a process comprising:
obtaining a measured value of temperature from a temperature sensor, the temperature sensor being encased in a housing of the portable electronic device;
calculating an estimated value of surface temperature of the housing using the measured value and a first heat transfer model when a touch sensor, which is able to detect touching to a surface of the housing, has not detected the touching, and calculating the estimated value using the measured value and a second heat transfer model when the touch sensor has detected the touching; and
decreasing an upper limit for a clock frequency of a processor encased in the housing when the estimated value is higher than or equal to a threshold, and increasing the upper limit for the clock frequency when the estimated value is lower than the threshold.
